(19) United States
(12) Patent Application Publication
(10) Pub. No.: US 2025/0037088 A1
(43) Pub. Date: Jan. 30, 2025

(54) MATCHING METHOD AND SYSTEM

(71) Applicant: Integritee Corporation, Sherman Oaks, CA (US)

(72) Inventors: Victoria Aagaard, Sherman Oaks, CA (US); Ryan Surratt, Sherman Oaks, CA (US)

(73) Assignee: Integritee Corporation, Sherman Oaks, CA (US)

(21) Appl. No.: 18/385,254

(22) Filed: Oct. 30, 2023

(30) Foreign Application Priority Data
Feb. 6, 2018 (US) 62/627062
Nov. 29, 2018 (US) 16/204649

(51) Int. Cl. G06Q 10/1093; G06Q 30/0251; G06Q 50/00; G06Q 50/47

(52) U.S. Cl. CPC G06Q 10/1095; G06Q 30/0256; G06Q 50/01; G06Q 50/47

(57) ABSTRACT

A matching app provides a method of matching first and second users and may schedule a personal meeting between them. Potential matches are based, at least in part, upon the respective interests of the parties and their locations. Information is received indicating favored activities of the first and second users. When one user wants to personally meet the other user, the matching app proposes a suggested activity and a suitable nearby location. The proposed location and activity are displayed to a user on a communication device, allowing the first user to send an electronic message inviting the second user to meet to engage in the suggested activity at the proposed location.

### CROSS-REFERENCE TO RELATED APPLICATIONS

The present application claims the benefit of the earlier filing date of U.S. provisional patent application No. 62/627,062, filed on Feb. 6, 2018, entitled “Dating Application System and Method of Use”, the contents of which are hereby incorporated herein by reference.

### BACKGROUND

### Field of the Invention

The present invention relates generally to computer-assisted matching, and more particularly to a computer-assisted method and system for matching persons of similar interests, and for scheduling activities for two or more people to share.

### Related Art

Matching applications, or “apps”, such as those branded Tinder, Bumble. Match, and OkCupid, are well known in the art for searching for another person to build a personal relationship. Some social media matching apps merely seek to match a first user with another user that the first user considers to be attractive; these matching apps give little or no consideration as to whether or not such persons are interested in similar types of activities. While a potential match may look attractive, if that potential match does not share any similar interests with the person searching for a match, then it is unlikely that such parties will successfully pursue a relationship.

In addition, finding a suitable match online is just a first step. A user must still actually set-up a date, or personal meeting, with a promising match. Indeed, it is estimated that 75% of online matching app users are unsuccessful is because the parties are frustrated by attempts to schedule the actual date/meeting, or afraid to do so. This probably explains why only approximately 8% of matching app users successfully meet personally for a date/meeting.

### SUMMARY

Conventional matching apps such as Tinder. Bumble, Match, and OkCupid, match users with others who may or may not share the same interests. They do not assist a user in accomplishing the hard work of setting up the date in the form of a personal meeting, i.e., none of such matching apps help users actually go out on a date and/or personally meet the other party. It is entirely up to the user to determine how to convince the match to go out with them, select an activity, and schedule a time that works for both persons.

A person wanting to meet with a potential match must first find something to do with the potential match. Before scheduling a date/meeting, a user of the app must think of an activity that will be of interest to the potential match. That activity needs to be relatively nearby both of them. Even after deciding upon a suitable activity, a mutually-convenient time must be found that can be scheduled in advance by the user and the potential match. Thus, a user of such a matching app must determine where the date will be held, whether the proposed location is suitable for the planned activity, and when it will be held. Due to the complexity of setting up a date, many potential matches never actually meet in person to find out if they really enjoy each other's company.

Accordingly, there is an unfulfilled need in the field for a matching app that bridges the gap between selecting a potential match and actually meeting in person for a date.

Therefore, it is an object of the present invention to provide a matching app suitable for running on a user communication device that assists a user in setting a date with a selected potential match.

It is further object of the present invention to provide such a matching app that quickly and efficiently determines whether a user and his or her potential match have similar interests.

It is still a further object of the present invention to provide such a matching app that assists a user in selecting a suitable location relatively near the user and the potential match where they can engage in an activity of interest to at least one of such persons.

Still another object of the present invention is to provide such a matching app that is adapted to find a date and time when the proposed meeting can be held without conflicting with other commitments that the user and potential match have already scheduled.

It is also an object of the present invention to provide such a matching app that assists the user in learning about, and evaluating, a proposed location for a planned activity.

Yet another object of the present invention is to provide such a matching app adapted to assist a user in sending an electronic message to the selected match to invite the selected match to participate in the proposed date.

Briefly described, and in accordance with various embodiments thereof, the present invention provides a method of, and systems for, scheduling a date or other personal meeting between a first user and at least a second user. Some embodiments of such method and systems includes receiving information from the first user indicating activities in which the first user likes to engage. Information is also received indicating the approximate location of the first user; in some embodiments of the invention, such information may be derived from GPS signals received by the first user's communication device. The method and systems also include receiving information indicating activities in which a second user likes to engage. In some embodiments, the method and systems also include receiving information indicating the approximate location of the second user.

Upon detecting activities in which the first user and/or second user like to engage, the method and systems of the present invention determine a location generally near the first and second users at which one of such activities may be shared. The method and systems include displaying to the first user the identity of the second user, a suggested activity, and the determined location for engaging in such activity. In some embodiments, this information is displayed to the first user in the form of a graphical map, showing the location of the first user, the location of the second user, and the proposed location for the activity. The method and systems of the present invention allow the first user to send an electronic message to the second user, e.g., an email message, text message, chat message, or the like, including an invitation for the second user to meet with the first user to engage in such activity at the established location.

In various embodiments, the method and systems also include receiving information regarding calendar entries for the first user, establishing a date and time when the first user is available to meet with the second user to engage in the suggested activity, and displaying to the first user a date and time when the first user is available to meet with the second user to engage in the suggested activity. In some embodiments, this information is then incorporated within the aforementioned electronic message sent by the first user to the second user.

In various embodiments of the present invention, the invitation sent from the first user by electronic message to the second user is displayed to the second user, and the second user may send an electronic message back to the first user accepting or declining the invitation.

In some embodiments of the present invention, favorite activity information is received from the first user by providing a menu, or listing, of proposed activities to the first user, and allowing the first user to select two or more of such activities. Similarly, favorite activity information may be received from the second user by providing a menu, or listing, of proposed activities to the second user, and allowing the second user to select two or more of such activities. These listings might include outdoor activities (hiking, dog walking, tennis, golf, roller-blading), spectator sports (baseball games, footballs games, basketball games, hockey games), music (opera, rock concerts, symphonies), theater, movies, fine dining, religious events, and the like. If desired, either user may change their selection of favorite activities at a later time, as by returning to the menu of activities and changing their original selection. The matching app may be configured to look for similar themes, backgrounds, and/or interests, as between a searching user and a proposed matching user before presenting the searching user with potential matches for consideration by the searching user.

As mentioned herein, the proposed date/meeting may be displayed to the first user in a graphical map format, e.g., on an electronic screen of the first user's communication device. In some embodiments of the present invention, the first user may obtain additional information about the proposed location for the planned activity by simply touching, or clicking, the selected location on the displayed graphical map.

Apart from the features described above, various embodiments of the present invention also permit the first and second users to exchange chat messages with each other. On occasion, one of the two parties may suddenly stop engaging in the exchange of such chat messages, sometimes known as “ghosting” wherein one of the parties to the conversation appears to have disappeared. Some embodiments of the present invention include an anti-ghosting feature whereby a user who has not responded to a chat message within a prescribed time (e.g., 72 hours) receives an alert. In response to that alert, the non-responding party can either continue the chat or send a termination message to the other user indicating that they are no longer interested in communicating further. In the latter case, the matching app may be configured to un-match the two users; the user terminating the chat session will stop receiving any further chat messages from the other user immediately, while the user to whom the termination message is being directed will retain the ability to receive messages for a period of time, perhaps 24 hours, to facilitate his/her receipt of the termination message.

Apart from termination messages prompted by the matching app as a result of prolonged chat silence, some embodiments permit either user to immediately send a termination message to the other user without waiting for any particular time to pass. For example, each user may be provided with a “ghost” icon which, when touched or clicked by the user, causes a proposed termination message to be displayed to such user for sending immediately to the other user. In some embodiments of the invention, if a first user does not respond to chat messages from a second user for a pre-determined amount of time, the first user will receive one or more notifications alerting the first user that he or she should respond to the second user. If the first user fails to act on the notifications, the first user may receive ghosting demerits. After a certain number of demerits, the first user may be suspended for a given time.

In various embodiments of the present invention, a user may register an objection with the sponsor of the matching app regarding another user when the second user “flakes”, i.e., fails to attend a scheduled meeting without reasonable prior notice.

In some embodiments of the present invention, the method and systems of the present invention also permit a user to register a “fibbing” objection with the sponsor of the matching app regarding another user if, after meeting the other user on a scheduled date, it becomes evident that one user has misrepresented himself/herself to the other user; by way of example, such misrepresentation might involve using photographs of someone else or fibbing about his or her height, weight, career, ethnicity, sexual orientation, marital status, etc.

In some embodiments, advertisements from owners of locations for potentially hosting activities may be received for promotion to users of the above-described matching app. For example, such advertisements may promote restaurants, bars, coffee houses, theaters, amusement parks, or sports arenas. In the course of suggesting a proposed activity and location, the aforementioned matching app may search through such advertisements on a priority basis when establishing a proposed location at which such activity can be shared. The selection of an advertised location by the first user for a personal meeting with the second user may, in some embodiments, trigger a payment by the proprietor of such advertised location to a sponsor of the matching app in consideration for the benefit received by the advertiser.

In various embodiments of the present invention, the scheduling of a date prompts the first user and/or the second user to schedule ride-share transportation for transporting the first user and/or the second user to the location established for the date. In some embodiments, a user is prompted to schedule such ride-share transportation by an icon or visual alert which appears on a display screen on the user's communication device.

Various embodiments of the present invention also facilitate the purchase, by the first and/or second users, of a gift for the other user; the first and/or second users may be prompted by their communication devices to arrange for such a gift either in advance of the scheduled date, or following the scheduled date. Similarly, in some embodiments of the present invention, the first user and/or second user may be prompted by his or her communication device to purchase supplies (e.g., tennis balls for a tennis outing) in advance of the scheduled date. Such users might also be prompted to view instructional videos or slide show presentations to better prepare the user for the scheduled activity. In some embodiments, users may be prompted to make such purchases, or view such information, by an icon or visual alert which appears on a display screen on the user's communication device.

In some embodiments of the present invention, two users may decide that they will be exclusive to each other, meaning that they will not consider or accept potential dates from any other users. In this instance, information is received from the first user indicating that the first user does not wish to receive potential dates from anyone other than a particular second user, and information is received from such second user that the second user does not wish to receive potential dates from anyone other than such first user. In this event, the matching application may be used by such first and second users as a convenient way to schedule dates between themselves.

In other embodiments of the invention, a computing system for matching a first user with a second user includes logic configured to receive information from a first user indicating an approximate location of the first user, and indicating activities in which the first user likes to engage. The computing system also includes logic configured to receive information from a plurality of other users indicating the approximate locations of such other users, and activities in which the other users like to engage. The computing system further includes logic configured to compare the location of the first user with locations of at least some of the plurality of other users, along with logic configured to compare activities in which the first user likes to engage with activities in which at least some of the plurality of other users like to engage. The computing system further includes logic configured to select potential matches for the first user based upon the aforementioned location comparisons and activity comparisons. The computing system includes an electronic display for displaying to the first user information regarding the selected potential matches.

### BRIEF DESCRIPTION OF THE DRAWINGS

FIG. 1 is a system diagram showing a system for implementing the matching app in accordance with various embodiments of the present invention.

FIG. 2 is a system diagram showing logic components within managing server 12 of FIG. 1.

FIG. 3 is a system diagram showing components within User1's communication device 20 of FIG. 1.

FIGS. 4 and 5 are collectively a flow chart illustrating basic steps performed by a matching app in accordance with one embodiment of the present invention.

FIG. 6 is an alternate embodiment of the present invention wherein a search is made of the calendars of first and second users before proposing a date and time for a planned activity.

FIG. 7 is a further alternate embodiment of the present invention wherein searches of the calendars of the first and second users are made separately by each user's communication device before a proposed date is confirmed.

FIG. 8 is a flowchart of optional steps that may be performed by the matching app after the date is scheduled and before the parties meet with each other.

FIG. 9 is a flowchart of optional steps that may be performed by the matching app after the planned meeting.

FIG. 10A is an image displayed on a user's communication device for allowing a user to select favorite activities.

FIG. 10B is an image displayed on a user's communication device for allowing such user to see an image of a proposed match and favored activities of the proposed match.

FIG. 11 includes an image displayed by a user's communication device showing first and second users engaged in a chat prior to scheduling a date/meeting.

FIG. 12 is an image displayed on a user's communication device showing a graphical map indicating the locations of the users and the location of the proposed meeting place.

FIG. 13 is an image showing additional information about the planned meeting location.

FIG. 14 shows screen images from a user's communication device in the course of integrating the user's calendar into the invitation for a date.

FIG. 15 is an image displayed on the communication device of the user being invited to the proposed date.

FIG. 16 shows an image displayed on a user's communication device following a scheduled date/meeting.

FIG. 17 is an image of a suggested anti-ghosting message allowing one of the users to notify the other user that there is no longer an interest in pursuing the relationship.

FIG. 18 is an image displayed on a user's device shortly before the scheduled date to schedule transportation to the scheduled activity.

FIG. 19 is an image displayed on a user's communication device after a date has been scheduled reminding a user of the need to purchase supplies that may be needed for the planned activity.

FIG. 20 is an image displayed on a user's communication device to purchase a gift for another user, either in advance of the scheduled date, or following the date.

### DETAILED DESCRIPTION

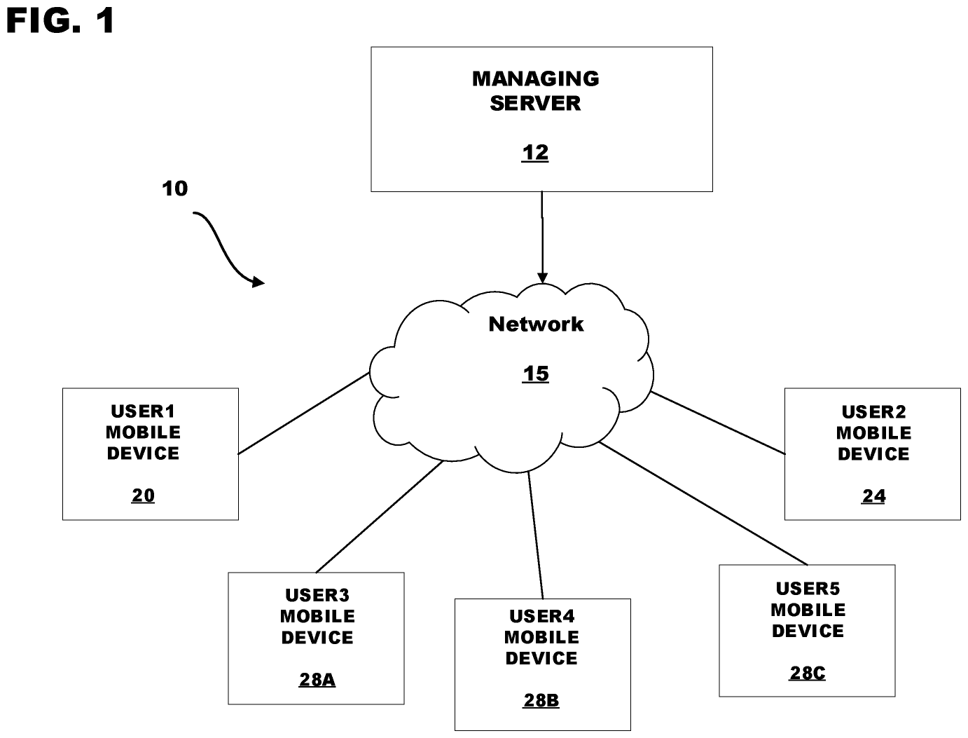

FIG. 1 illustrates a matching app system 10 according to various embodiments of the invention. Matching app system 10 includes a central managing server 12 and at least two user communication devices 20 and 24 for a first user (User1) and a second user (User2), respectively. As indicated in FIG. 1, additional communication devices 28A. 28B. 28C, etc., for other users are typically included in such a system. Such communication devices may be, for example and without limitation, smart-phones, computer tablets, laptops, desktop computers, or the like. User communication devices 20/24/28A/28B/28C are configured to communicate via a Network 15 with Managing Server 12. Network 15 may be a telephone network, a computer network (e.g., the internet), and/or some other communication network.

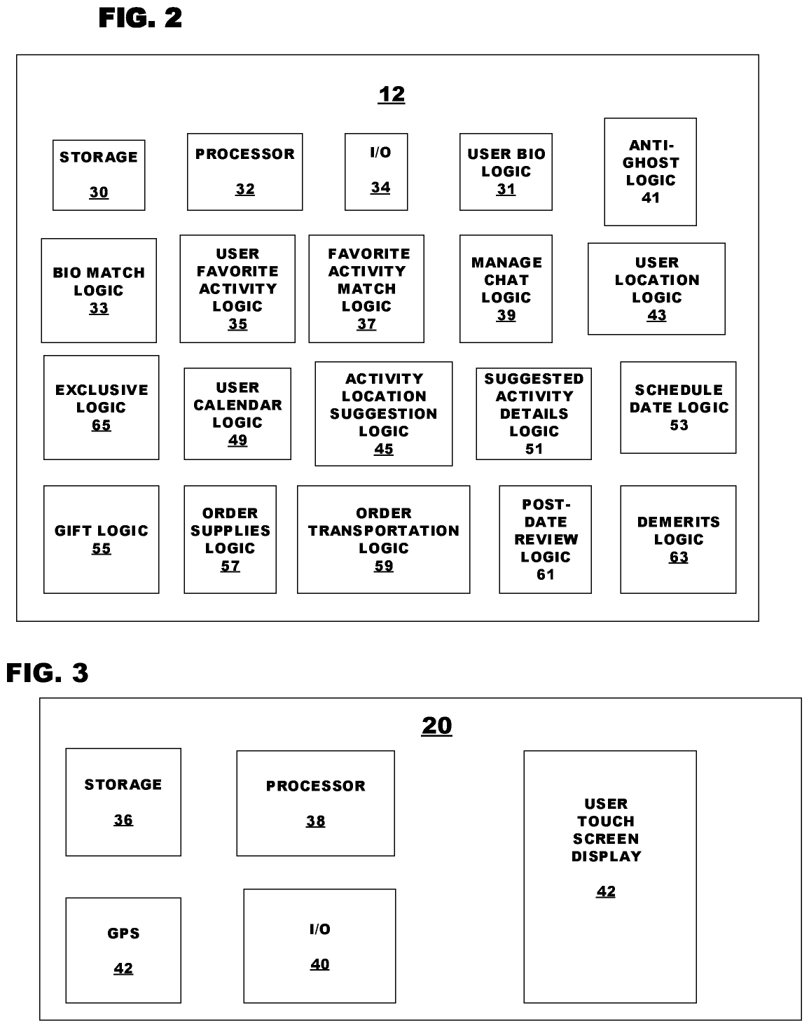

FIG. 2 is a block diagram illustrating some of the components within managing server 12. Server 12 includes a processor 32 for computing data in accordance with software instructions provided to processor 32 by storage unit 30. Storage unit 30 also stores user data for users who have subscribed to the matching app, and exchanges such user data with processor 32. For example, for each user who has subscribed to the matching app, storage unit 30 may store one or more photographs of the user, as well as the user's name, place of residence, age, and occupation; this information may be uploaded to server 12 by each user during the subscription process. Alternatively, such information may be stored in User Bio Logic block 31, which may be configured to store one or more photographs of the user, as well as the user's name, place of residence, age, and occupation. Storage unit 30 may also store information regarding suggested activities (restaurants, bars, sporting arenas, etc.), along with reviews of such venues. Storage unit 30 may also be used to store information regarding subscribed users, including reviews, comments, and even penalty/demerit scores for past instances of poor etiquette. Server 12 also includes an input-output (I/O) unit 34 for transmitting and receiving data over network 15.

Still referring to FIG. 2, managing server 12 may also include Bio Match Logic 33 configured to compare biographical information of a selected user to the biographical information of other users who have subscribed to the matching application. For example, a user (“User1) may be looking for potential candidates to go out for a date and desires to find other people of similar background, education level, age and location. Bio Match logic 33 is configured to compare such factors for User1 to the same factors stored for other users and creates a subset of other users that can be presented for viewing by User1, User1 may decide, after viewing photos of such subset of users, that some of those potential candidates are not attractive or otherwise desired; this selection process may involve, for example, swiping the user's communication device touch screen in one direction for a desired candidate, and swiping the user's communication device touch screen in the opposite direction for someone who is not desired. The user's responsive “swipes” are communicated to, and noted by. Bio Match Logic 33, which is configured to create a narrowed subset of potential candidates. The narrowed subset of potential candidates for User1 is also referred to herein as the User match subset.

As shown in FIG. 2, managing server 12 may also include User Favorite Activity Logic 35 configured to present to each user a menu, or listing, of possible activities and allowing each user to select one or more of such activities that are most favored by such user. Such possible activities might include playing tennis, playing golf, going to a movie, going to a baseball game or basketball game, etc. Managing server 12 may also include Favorite Activity Match Logic 37 configured to compare the favored activities selected by User1 to the favorite activities selected by other users. Favorite Activity Match Logic 37 is configured to detect potential match candidates for User1 who have selected the same, or related, favorite activities that were selected by User1. The resulting candidates may then be presented to User1 on User1's communication device 20 to allow User1 to select one or more of such resulting candidates for dating/meeting.

Before actually attempting to schedule a date/meeting, potential partners are provided a chance to communicate with each other, as by sending so-called “chat” messages. For example, User1 might send a message to User2 saying “Hi, I'm Tom—looks like we both play tennis. How's your game” User2 might reply “Not bad . . . bet I could take you”. Managing server 12 includes Manage Chat Logic 39 configured to allow User1 and User2 to exchange such chat messages. Also included is Anti-Ghost Logic 41 which is configured to monitor chat exchanges between pairs of users, and to detects chat messages that are not answered within a reasonable amount of time, e.g., within two-three days. Anti-ghost logic 41 may also be configured to send a reminder alert to the user who has not yet responded reminding them that it is rude not to respond, and perhaps even suggesting a message that might be sent to the other user indicating that there is no longer an interest in pursuing the relationship further. Anti-ghost logic may also be configured to be responsive to activation of a screen icon by either of the two users, either to remind the non-responding user to respond, or to suggest a termination message ending the relationship.

As shown in FIG. 2, managing server 12 may include Activity Location Suggestion Logic 45 configured to suggest a potential activity and host location in anticipation of an actual date/meeting. Also included in FIG. 2 is User Location Logic 43, which is configured to receive information from User1 indicating the geographical location of User1, and to receive information from User2 indicating the geographical location of User2; typically, both such users consent to sharing their location coordinates with managing server 12 when subscribing to the matching app. Based upon the results of the Favorite Activity Match Logic 37, current “chat” history, and relative locations of User1 and User2. Activity Location Suggestion Logic 45 is configured to determine a potential activity and host location that can be proposed by User1 to User2 for a date/meeting. In some embodiments of the invention, managing server 12 includes User Calendar Logic 49 configured to access the appointment calendar of User1 and to find one or more available date/time slots before presenting a potential date to User1. In other embodiments. User1 first views the activity and host location proposed by Activity Location Suggestion Logic 45; User Calendar Logic 49 is configured to allow User1 to subsequently access User1's calendar to select a date and time. Managing server 12 may also include Suggested Activity Details Logic 51 configured to allow User1 to learn more details of the host location (directions, hours of operation, fees, amenities, etc.).

Managing server 12 also includes Schedule Date Logic 53 configured to generate a date invitation message for transmission from User1 to User2 indicating the suggested activity, the proposed host location, and the date and time to meet. Schedule Date Logic 53 may also be configured to add the proposed date to User1's appointment calendar, along with a note that the date is yet to be confirmed by User2. Schedule Date Logic 53 is also configured to be responsive to a reply from User2, which reply may, for example, take the form of User2 accepting and confirming, or declining, or requesting that the proposed date be re-scheduled to a different time and/or day. If User2 confirms the proposed date. Schedule Date Logic may be configured to access the appointment calendars of both User 1 and User2; User2's calendar is modified to show the scheduled date, and User1's calendar is modified to change the status of the proposed date from unconfirmed to confirmed.

Managing server 12 of FIG. 2 may also include Gift Logic 55 which may be configured to facilitate the ordering of a gift by User1 for User2 (or conversely, by User2 for User1) after the date has been scheduled and before the scheduled date. Gift Logic 55 may be configured, for example, to suggest a gift of flowers, candies, etc., and to provide a link to the user for ordering such gift to be delivered to the other user in advance of the date. Gift Logic 55 may also be configured to be operative after the users have met for the date, for sending an inquiry to a communication device for either, or both, users asking whether such user desires to send a gift to the other user following the date. Managing server 12 may also include Order Supplies Logic 57 configured to send an inquiry to either or both users asking whether such user needs to order any supplies (e.g., tennis balls, or a new tennis racket, in advance of a tennis outing) to prepare for the upcoming date, based upon the planned activity; if so. Order Supplies Logic 57 may be configured to supply a link to the user's communication device to facilitate the placing of such order. While Order Supplies Logic 57 typically relates to supplies, it may also be configured to suggest instructional videos, or coaching services, to better prepare the user for participating at the scheduled activity. In addition, managing server 12 may include Order Transportation Logic 59, which may be configured to prompt one or both users to arrange for transportation. e.g., a ride-sharing service like Uber or Lyft, to transport User1 and/or User2 to the location hosting the scheduled date; such arrangements are facilitated by User Location Logic 43 which is configured to provide the geographical location of both users, and by Schedule Date Logic 53 which is configured to provide the host location.

All of such host location fee payments, gift purchases, supplies purchases, and transportation purchases may potentially result in the payment of compensatory fees to the sponsor of the matching app as a referral source. Similarly, host location fee payments, gift purchases, supplies purchases, and transportation purchases may potentially be entitled to discounts negotiated by the sponsor of the matching app as an incentive to its subscribers.

As further shown in FIG. 2, managing server 12 may include Post-Date Review Logic 61 configured to gather information about the date after it has taken place. Among other things, each user is asked whether the other user actually appeared at the date or “flaked” instead, and to review the activity and host location for recommendation and/or warnings to others. In addition. Post-Date Review Logic 61 may be configured to ask each user whether the other user “fibbed” about his or her appearance, interests, background, age, etc., within the user profile saved on the matching app for such user. Managing server 12 also includes Demerits Logic 63 which is configured to analyze ghosting information gathered by Anti-Ghost Logic 41, and flaking and fibbing information gathered by Post-Date Review Logic 61, to determine whether the guilty user should receive demerits, or have their subscription suspended or revoked.

Managing server 12 of FIG. 2 may also include Exclusive Logic 55 which is configured to effectively pair User1 and User2 exclusively to each other. If User1 and User2 have decided that they will date each other exclusively (i.e., they will not initiate or accept dates from other users of the matching app), then User1 and User2 may both indicate to Exclusive Logic 55 that they should be considered “exclusive”. In this case, the matching app will no longer suggest either User1 or User2 as a likely match for any other users. However. User1 and User2 may continue using the matching app as a convenience to schedule future dates between themselves.

FIG. 3 is a block diagram of User1's communication device 20. User device 20 includes storage 36, processor 38, and a touch screen 42 for both displaying information to a user and receiving information from the user, and input-output (I/O) block 40 for transmitting and receiving information over network 15. I/O block 40 may be configured to communicate with cellular communication towers, and may also be configured to communicate with a wireless WiFi network. If communication device 20 is a mobile communication device, e.g., a smart phone, then it might also include a GPS receiver 42 for deriving a user's location. User1's communication device could also be a fixed-base computer, e.g., a desktop computer; in that case, screen 42 might be a display solely for conveying information, and the user might use a keyboard and/or graphical pointing device (e.g., a computer mouse) to input information. Desktop computers typically do not include a GPS receiver, but the user's location might be derived from the user's network configuration, or simply by having the user enter his or her location manually.

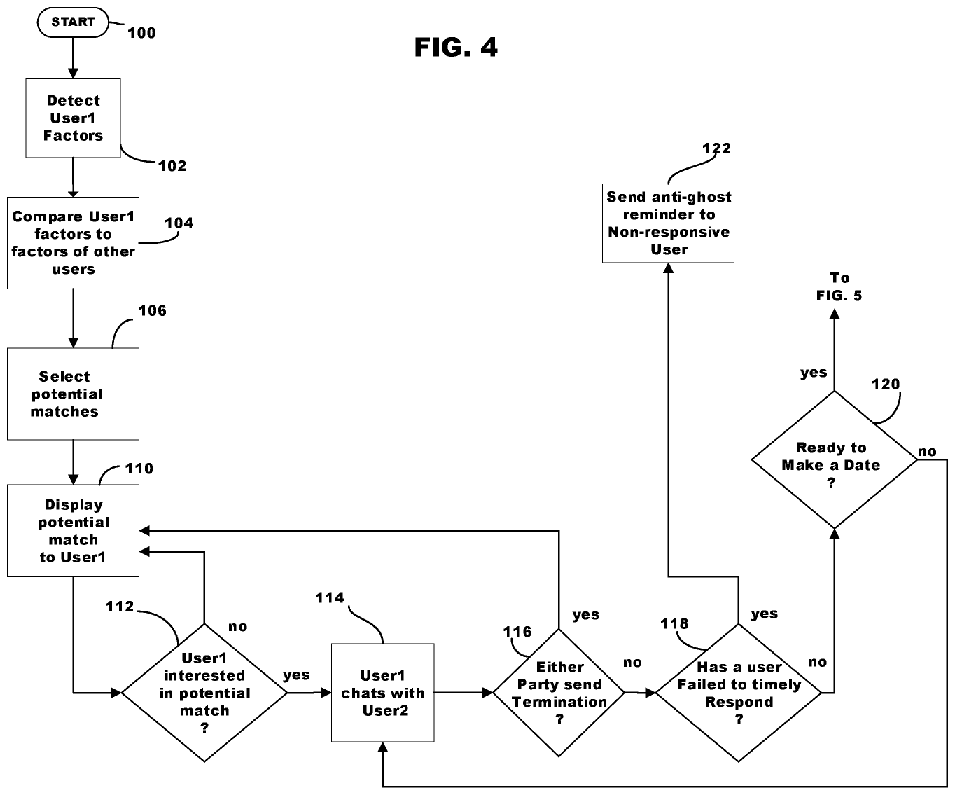

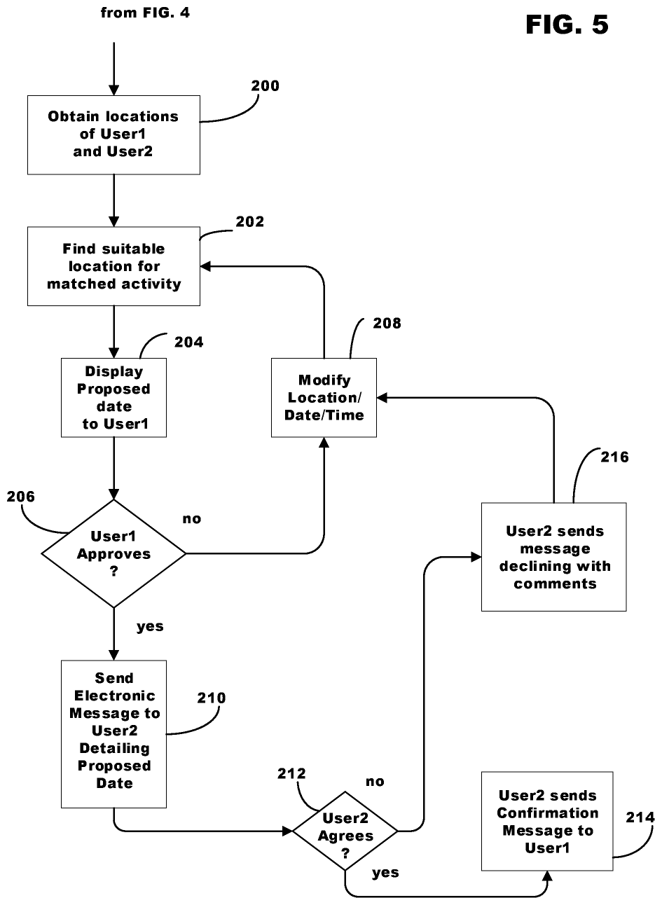

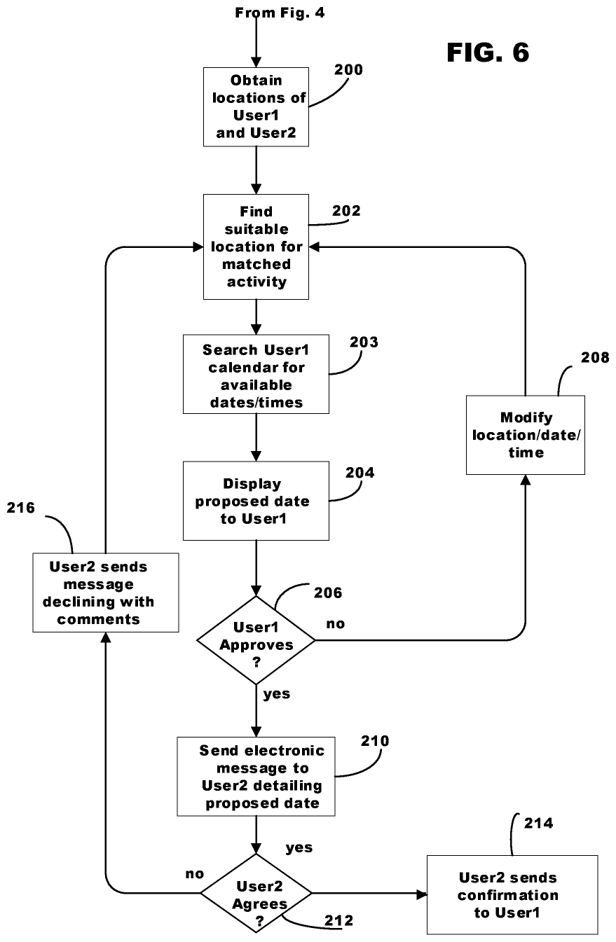

FIGS. 4 and 5 collectively form a flowchart showing basic steps performed by a matching app system in accordance with various embodiments of the invention. In FIG. 4, a first user. User1, who is seeking a match, begins at Start 100 by downloading and installing a matching software application, or app, on his or her communication device 20, and running the installed app. User1 is prompted to upload a photograph of User1, and basic information about User1, including, for example, the user's name, place of residence, age, education, ethnicity, religious preference, sexual orientation, and/or occupation; as explained herein. User1 will also select a number of activities that User1 enjoys. This information may be transmitted by User1 over network 15 to server 12 for being saved in storage 36, and all of these factors help to characterize User1. Other users, including User2, provide their own information using their own user communication devices in a similar manner, whereby storage 36 contains a set of factors for each user that help to characterize each such user.

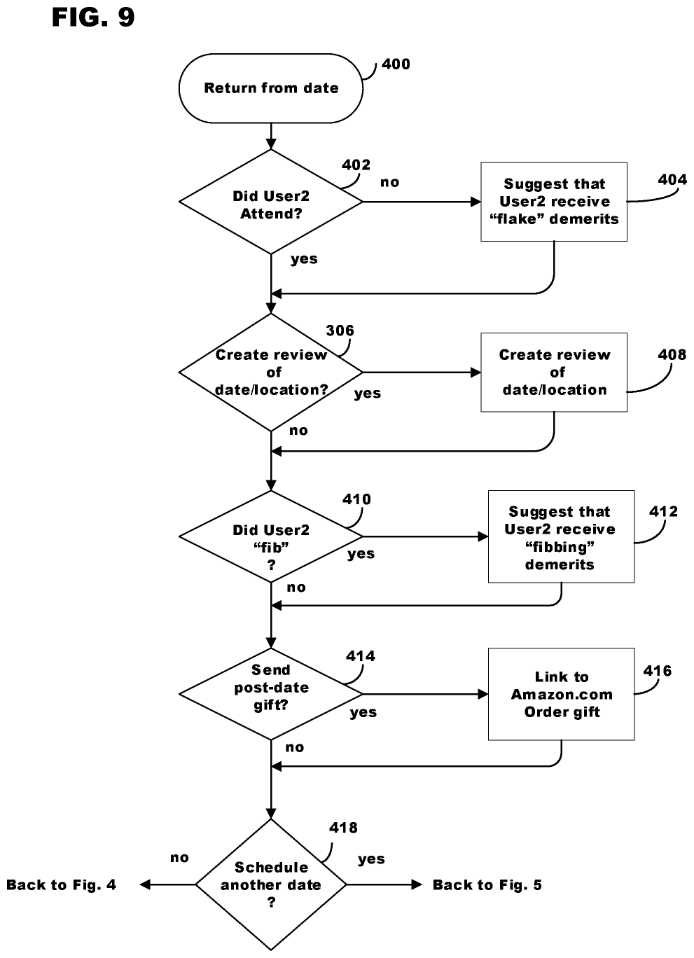

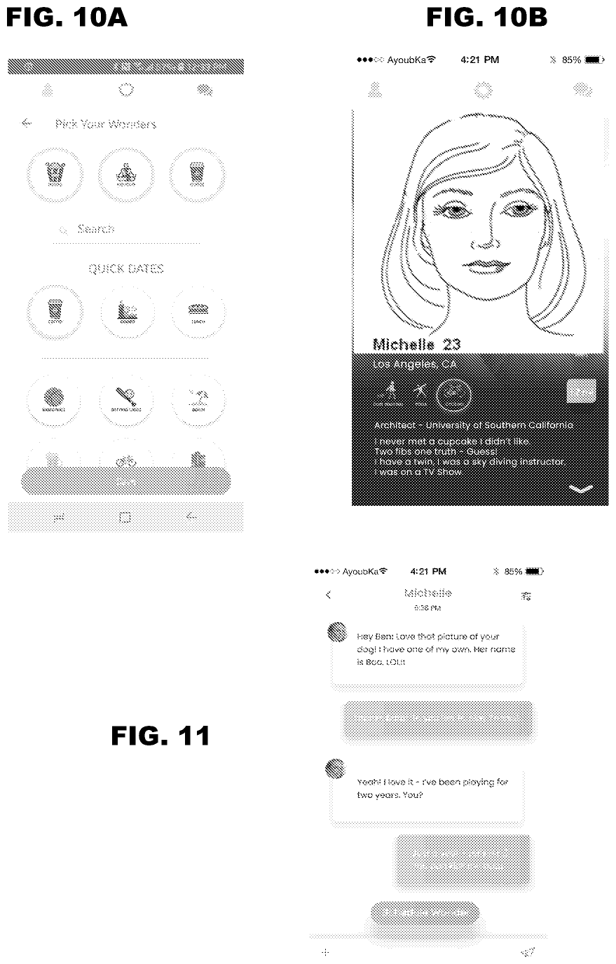

Still referring to FIG. 4. User1 may log-in to the matching app to search for a potential match. Managing server 12 detects stored factors for User1, as indicated by block 102 in FIG. 4. This may be accomplished, at least in part, using User Bio Logic 31 and User Favorite Logic 35 in FIG. 2. Managing server 12 then compares such factors for User1 to factors stored for the other users, as indicated by block 104 in FIG. 4. This may be accomplished, at least in part, by using Bio Match Logic 33 and Favorite Activity Match Logic 37 in FIG. 2. The results of such comparisons are used by managing server 12 to select potential matches for User!, as indicated by block 106 in FIG. 4. A series of potential matches for User1 are displayed to User1 on the display of User1's communication device by the matching app, as indicated by block 110 in FIG. 4. For example, a series of screens may be sent by server 12 to User1's communication device display, each showing the photograph of a potential match along with such person's name, age and residence, similar to that shown in the screen image appearing in FIG. 10B. User1 may optionally narrow the search by selecting (e.g., swiping right) or de-selecting (e.g., swiping left) each displayed image to create a pool of potential matches that User1 finds to be attractive. This selection process by User1 is indicated in FIG. 4 by decision diamond 112. User1's communication device 20 may upload such selections, and de-selections, to server 12 for being saved in storage 30. In a similar manner, storage 30 may be used to store similar selections, and de-selections, made by other participating users.

After User1 has finished narrowing the field of potential matches in the manner described above, it is time to find a potential match for a date/meeting. As mentioned herein. User1 is prompted to select from a list of suggested activities; examples might include hiking, biking, tennis, movies, theater, baseball games, etc. These selections may be used to help characterize User1 for matching purposes. These selections may also be used to create a suggested activity for User1 and a potential match to attend together. Some of these suggested activities may be seasonal (e.g., ice skating in the winter) or holiday-related (e.g., a Haunted Hayride around Halloween). Other suggested activities (so-called “quick dates”) are more common, e.g., meeting for ice cream, drinks, or coffee. User1 may optionally select one of these quick dates instead of a favorite activity that had been previously selected by one or both users. Referring briefly to FIG. 10A, the screen image shown is representative of the choices of icons displayed to User1 for selection. Users are encouraged to select three potential activities that the user enjoys to facilitate the suggestion of a proposed activity to be shared with another user. In some embodiments, users may be allowed to select more than three potential activities, e.g., by paying for a premium membership.

As User1 selects an icon designating a particular potential activity, that icon moves to the top of the display screen, until all three of User1's selections appear at the top of User1's display screen. These potential activities are listed as icons and/or text on User1's profile that can be viewed by other users. Users may change their top-three selections for potential activities at any time, as by de-selecting one of their chosen activities and selecting a new potential activity to replace it. User1's selections may be uploaded to server 12 and saved in storage 30.

As mentioned herein. User1's characterizing factors, which includes User1's selection of favored activities, are compared to characterizing factors stored for other subscribing users. This comparison step could be performed by processor 32 of server 12. Further, this comparison step could be performed against all other subscribing users, or it could be limited to a narrowed pool of other users whom User1 already selected based upon appearance, as by swiping right: it could be further limited to only those other users who have also “swiped right” when viewing the profile of User1. Step 106 in FIG. 4 designates the result of such factor comparisons as a series of potential matches.

Potential matches are displayed to User1 on communication device 20, as indicated by step 110 in FIG. 4; a number of icons representing favored activities of the potential match may also be displayed, and if one of such activities is favored by both User1 and the potential match, then that activity icon may be highlighted, as by being surrounded by a circle, to emphasize an activity favored by both of such users. If User1 is not satisfied with a displayed potent match, then flow proceeds from decision diamond 112 back to box 110, for displaying the next potential match for User1. On the other hand, if User1 is interested in the proposed match, then flow proceeds from decision diamond 112 to box 114 in FIG. 4, and User1 initiates a chat session with a potential match. An example of such a chat session is shown in FIG. 11, wherein the screen image illustrates messages exchanged between User1 and User2.

After sufficient “chatting”. User1 may decide that the time is right to schedule an actual date/meeting. In decision diamond 120 of FIG. 4, this is represented by the “Yes” arrow leading to FIG. 5. Alternatively, if User1 is not yet ready to commit to a date, the parties can continue to “chat”, and flow returns to box 114.

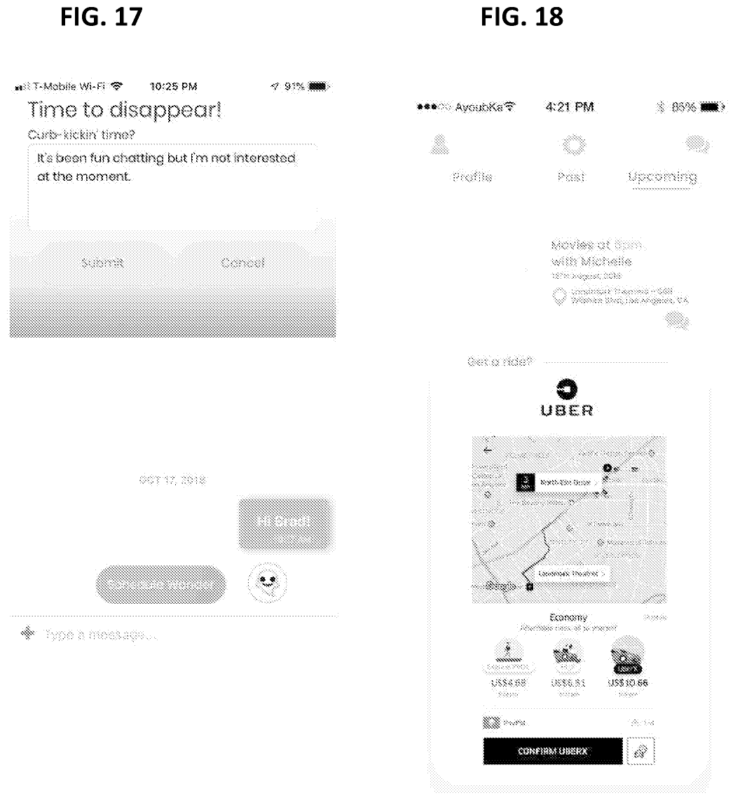

Before leaving FIG. 4, the concept of “ghosting” will be addressed. On occasion. User2 will stop responding to chat messages from User1 without explanation or apparent excuse, as it User2 has become a “ghost” and disappeared. Alternatively, it may be the case that User1 is actually the party that has stopped responding to chat messages from User2. This problem is represented within FIG. 4 by decision box 118. This is an example of poor matching app etiquette. In this case, the matching app system may remind the non-responding user that they have not responded to a chat message from the other user for an excessive amount of time (e.g., 72 hours), as indicated by box 122 in FIG. 4. This reminder might be generated by software on the communication device of the non-responding user, or this reminder might be sent by managing server 12 to the non-responding user's communication device. This reminder might be in the form of a proposed message to the other user indicating that there is no longer an interest in pursuing the relationship further, as shown in FIG. 17. Once such termination message is sent to the other user, the matching app will “un-match” the two users; the terminating user will no longer receive messages from the terminated user. The terminated user will continue to receive chat messages from the terminating user for a brief period, simply to help insure that the termination message is viewed by the terminated user.

In some cases, one of the users who had been engaged in a chat session may decide that they are not interested in the other user, and they do not wish to wait 72 hours to be reminded that they have not responded to the latest chat message; rather, as a matter of courtesy, they simply wish to notify the other user that the they are no longer interested. As shown in FIG. 11, each user's chat screen includes a “ghost” icon, and in the event that one of the users has decided not to continue chatting, the user can press the “ghost” icon to create a pre-programmed message advising that the conversation has been terminated: this pre-programmed message may be an editable pre-programmed message whereby the user has the option to change the message before sending it. As shown in FIG. 4, if either party has sent a termination message to the other party, decision diamond 116 directs flow back to box 110 to display a new proposed match for User1.

If a User1 does not respond to chat messages for a pre-determined amount of time. User1 will receive notifications alerting them, either via their chat with User2 turning red, via pop-up, or via push-notification, that User1 should respond to User2. If User1 fails to act on the notifications. User1 may receive ghosting demerits. After a certain number of demerits. User1 may be suspended for a given time. User1 may wait until that suspension passes or may pay for the premium membership to have suspension removed.

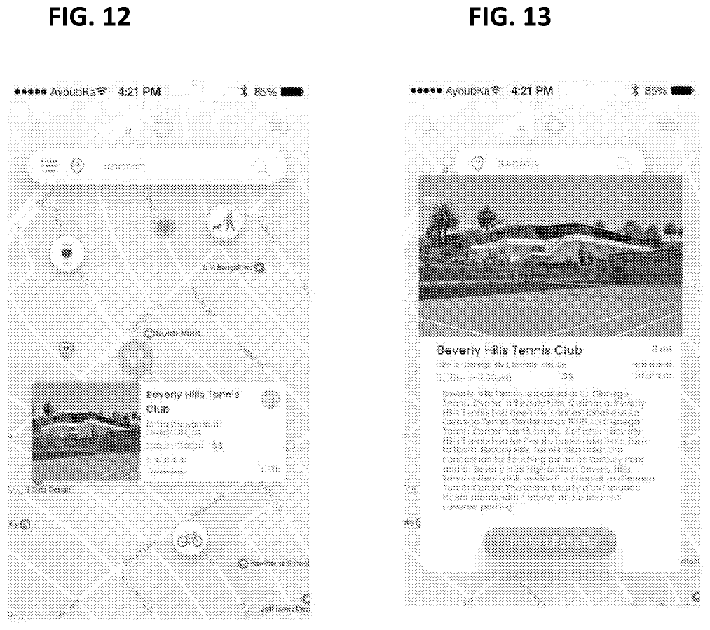

Referring again to FIG. 11, the “chat” display screens on the communication devices of User1 and User2 each include a “Schedule Wonder” button at the bottom of the screen that either user may select in order to schedule an activity. Assuming that User1 actuates the “Schedule Wonder” button, then server 12 determines the current locations of User1 and User2, as indicated by box 200 in FIG. 5. User1 and User2 have already consented to having the matching app system access their location data derived from their respective communication devices. User1 either selects the activity that the parties have both selected in advance, or selects one of the “quick dates” already described. This selection is uploaded to server 12, which then searches for a facility/location reasonably near User1 and User2 at which the selected activity can be enjoyed, as indicated by step 202 in FIG. 5. After finding a suitable location, server 12 downloads the suggested location to User1's communication device for display, as indicated by step 204 in FIG. 5. In some embodiments of the invention, this display is in the form of a graphical map, with the suggested activities/locations shown as icons on the map, as shown in FIG. 12. User1 can touch an activity icon displayed on such map to display the name of the facility/restaurant/etc. will appear along with the address, rating stars (for reviews), price range (using dollar signs), hours of operation, and/or a phone number where available, as shown in FIG. 12. The User can also “click” on the selected facility to learn more about it, and to schedule an activity at that location. If a phone number is displayed, then User1 can click on the displayed phone number to initiate a phone call to make a reservation.

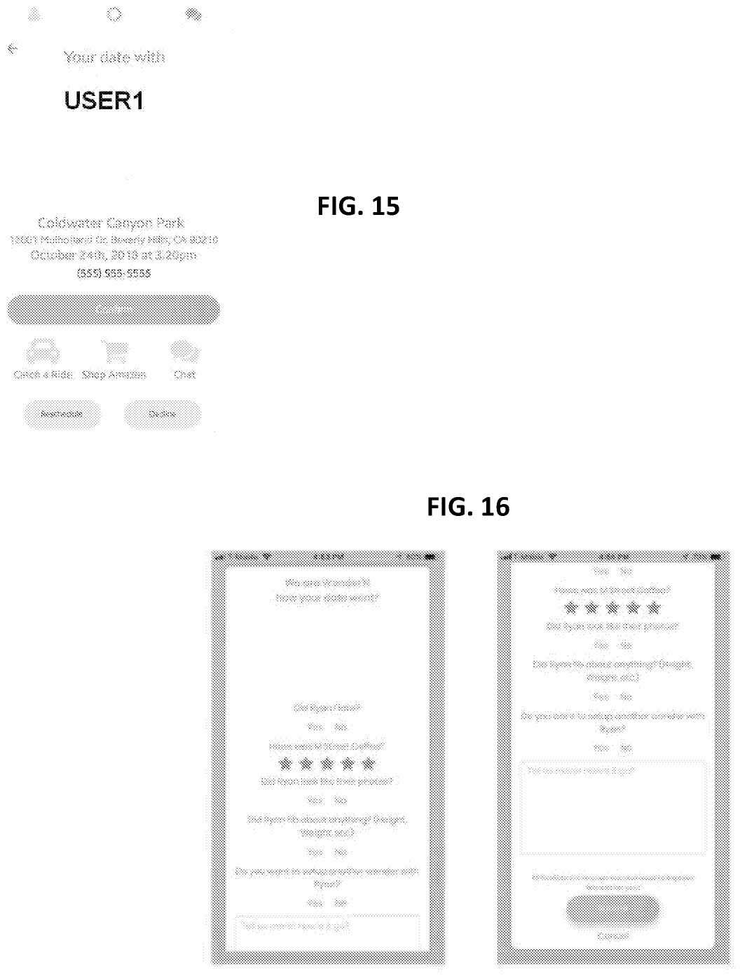

User1 is provided the opportunity of approving, or disapproving, the proposed activity and location, as indicated by decision box 206 in FIG. 5. If User1 is not satisfied, then flow proceeds to step 208, and User1 modifies the activity/location. Alternatively, if User1 is satisfied with the proposed activity/location. User1 may send an invitation message to User2 advising of the proposed date, as indicated by step 210 in FIG. 5. Referring briefly again to FIG. 13, an “Invite” button appears at the bottom of User1's screen to send the electronic invitation to User2. As further shown in FIG. 15. User2 views a display of the invitation, and considers the proposed date at decision box 212 of FIG. 5. User2 may confirm the date by pushing the “Confirm” icon shown in FIG. 15 (corresponding to step 214 in FIG. 5). Alternatively. User2 may decline the date by pushing the “Decline” icon, or request that the date be rescheduled by pushing the “Reschedule” icon, as shown in FIG. 15 (corresponding to step 216 in FIG. 5.

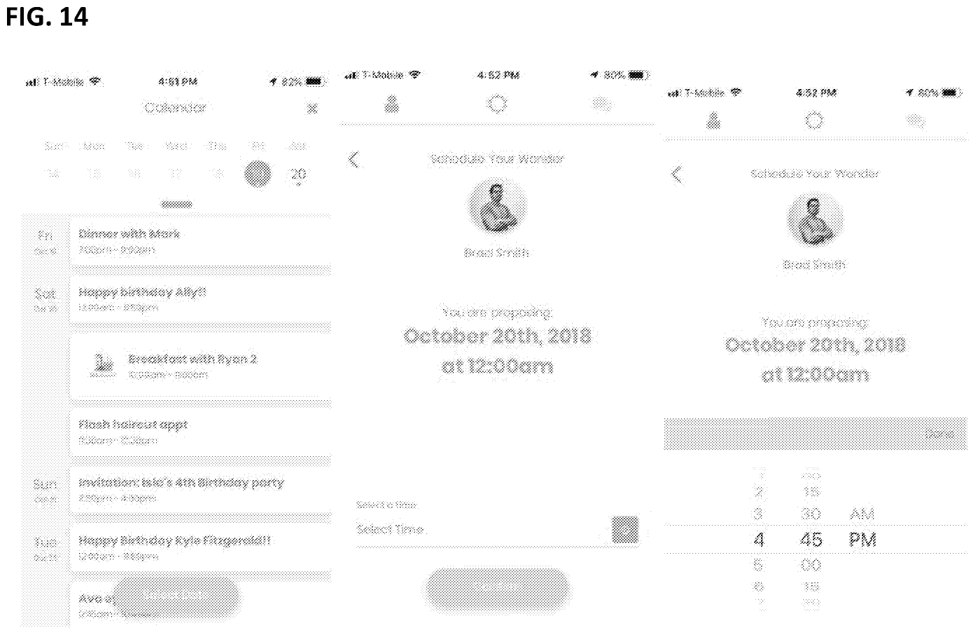

Another feature of some embodiments of the invention is the integration of the appointment calendars of one or both users in scheduling the proposed date. FIG. 6 is a flowchart similar to that of FIG. 5 but including integration of the appointment calendar of User1. Once User1 has determined the activity/location for the proposed date, the matching app searches the appointment calendar of User1 to find a date and time during which User1 is available to attend the proposed date, as reflected by step 203 in FIG. 6. This search may be made on User1's communication device 20 itself, but might be more easily performed by server 12, provided that User1 has already consented to access of User1's appointment calendar by the matching app server 12. A proposed time and date may be automatically suggested as a result of such search; alternatively. User1's calendar is displayed to User1 by the matching app system on User1's communication device 20, as shown in FIG. 14, and User1 is then able to select a date and time when User1 is available. After selecting the time and date, those details are incorporated into the invitation, and User1 proceeds to send the invitation to User2 (see step 210 in FIG. 6), and then invite the Match to that date. Optionally, the activity, location, date, and time, are added to User1's calendar with a notation that the date has yet to be confirmed by User2.

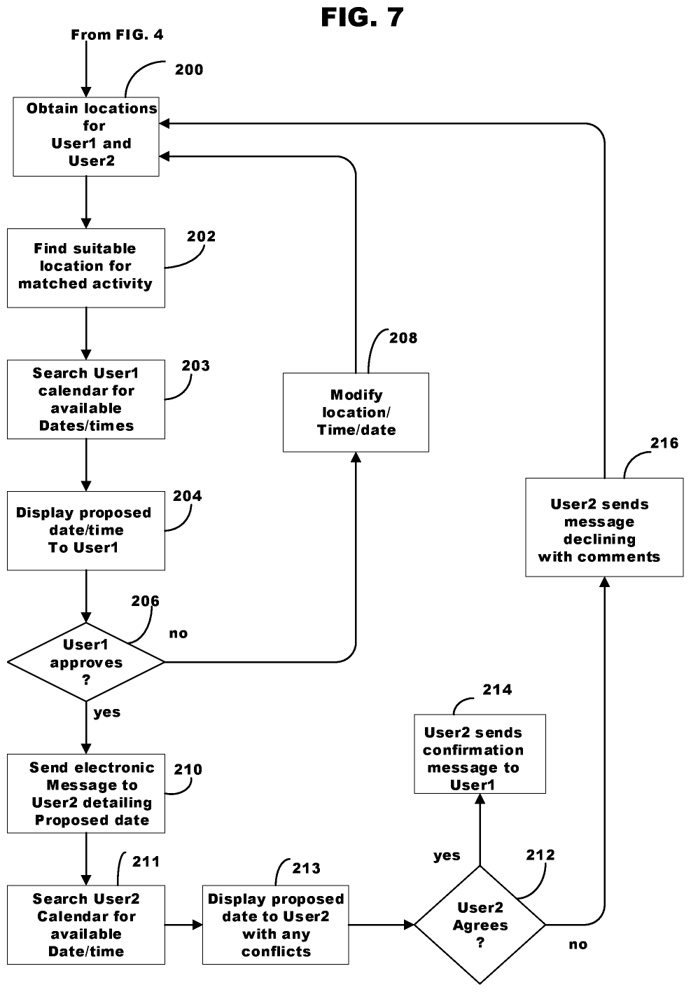

The same calendar integration technique can be incorporated into User2's processing of the invitation received from User1, as shown in FIG. 7. Upon receiving the electronic invitation. User2's calendar can be automatically accessed, as indicated by step 211 in FIG. 7. User2's calendar is displayed to User2, as per step 213 in FIG. 7, to determine whether User2 is available on the date and time proposed by User1 before confirming or declining the invitation. If User2 confirms the date, the activity, location, date, and time, may be automatically added to User2's appointment calendar. Also, once User2 confirms the date, User1's calendar is updated to change the status of the scheduled date from “unconfirmed” to “confirmed”.

In the event that User2 declines the invitation sent by User1. User1's communication device 20 receives a notification from server 12 advising that User2 has declined invitation, perhaps including User2's reason for declining and/or User2's request for rescheduling, and inquiring whether User1 would like to suggest a different date or time, or a different activity. Alternatively. User1 and User2 might be returned to the “chatting” loop in FIG. 4 so that User1 and User2 can discuss the reason why the invitation was declined and whether they want to Reschedule.

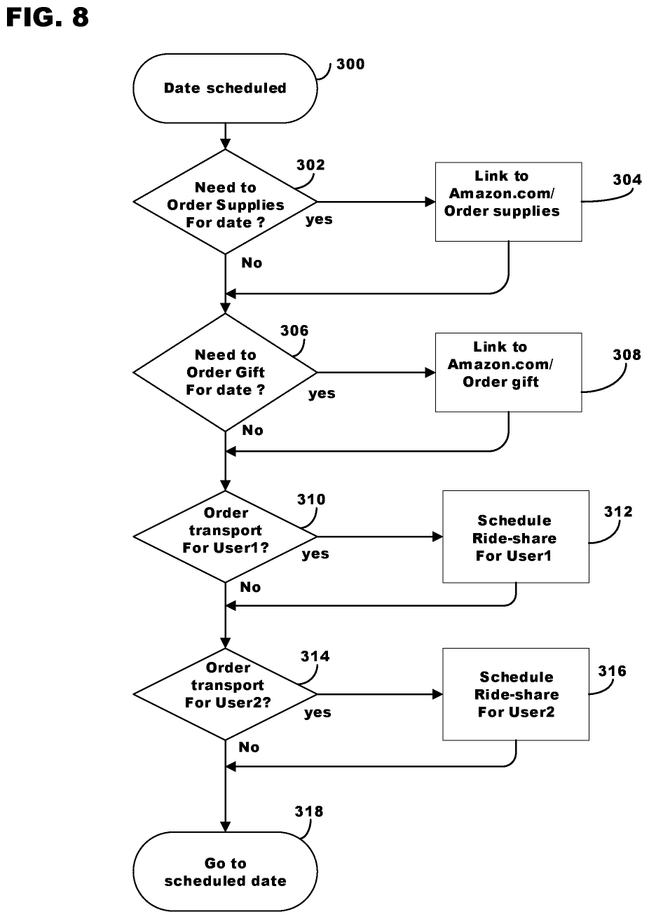

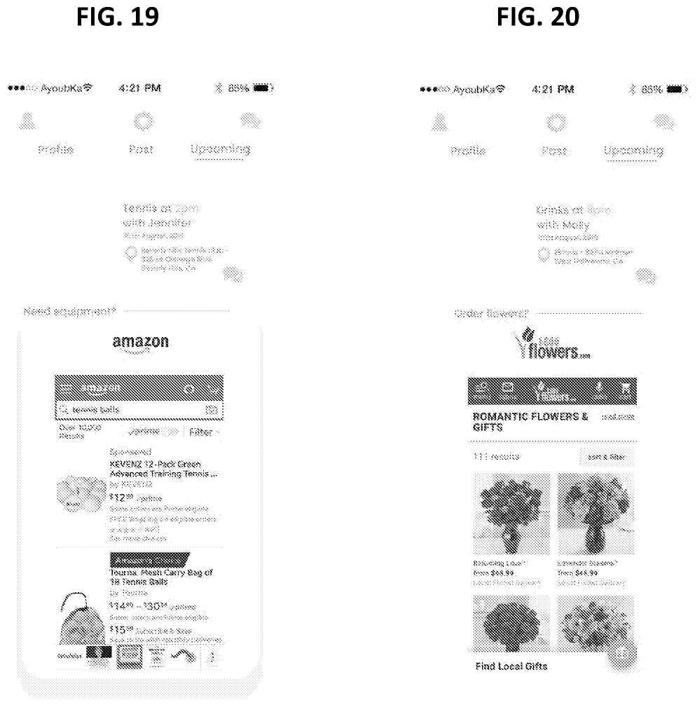

The flowchart of FIG. 8 details further steps that may be accomplished after a date has been scheduled (see step 300) and just before the parties meet at the date (see step 318). Decision box 302 in FIG. 8 prompts User1 (and/or User2) to consider whether they need to purchase any supplies that will be needed at the scheduled date. If the answer is “yes”, then the matching app links the user's communication device to a website of a supplier, as per step 304. For example, if the users will be meeting to play tennis. User1 might be prompted to purchase tennis balls or new tennis clothing, as shown in FIG. 19.

Flow may then optionally proceed to decision box 306 of FIG. 8, prompting User1 to decide whether a gift should be sent to User2 in advance of the date. If User1 agrees, then the matching app links the user's communication device to a website of a gift supplier, as per step 308. For example. User1 might be sent to the website of a florist, as shown in FIG. 20.

On the day of the scheduled date, User1 may be prompted to order transportation, for example, a ride-share via Uber or Lyft, to transport User1 and/or User2 to the location for the scheduled activity. These decisions are represented in FIG. 8 by decision boxes 310 and 314, and if User1 agrees, then the matching app links the user's communication device to a website of a ride-share sponsor, as per steps 312 and 316. For example. User1 might be sent to the Uber website, as shown in FIG. 18. The locations of User1. User2, and the destination are already coordinated through the matching app system for transmission to the ride-share site.

Following the scheduled date, some embodiments of the invention provide additional features for the users, as shown in the flowchart of FIG. 9. After returning from the date (see step 400 in FIG. 9), each user receives a message from server 12 seeking information, as shown in FIG. 16. For example, decision box 402 in FIG. 9 asks whether the other user actually attended the scheduled date; if not, the reporting user is taken to step 404, where “flaking” demerits may be assessed against the user who failed to attend without adequate advance notice. A user will receive a “warning” alerting them to their indiscretion each time they “flake” and will receive a flake demerit. “Flaking” consists of either cancelling a date without adequate warning; or failing to show up for a scheduled date. If a user “flakes” more than a certain number of times within a given time period, the user's account will be suspended for a certain amount of time. Such user may wait until that suspension passes or may pay for the premium membership to have the suspension removed. A user may report that their proposed match has flaked either by leaving a review, or by contacting the sponsor of the matching app system via a “contact us” button on the user's profile page.

Flow then passes to decision box 406, wherein the user is asked whether the user wishes to leave a review of the other user, or a review of the activity/location, as per step 408. For example, the reporting user may report whether he or she would like to go out on a second date with the other user or not. The reported results might not necessarily be made public, but may be considered by the sponsor of the matching app when deciding whether or not to allow a subscriber to continue participating. Control then passes to decision box 410 where the reporting user is asked whether the other user “fibbed”, i.e., misrepresented himself or herself within such user's online profile. For example, the “fibbing” user may have used out-dated photos, or even photos of someone else, or falsely described their height, weight, age, occupation, or proficiency in an activity. Such matters can be reported at step 412. Again, such information might not be made public, but may be considered by the matching app sponsor when deciding whether such user may continue participating. A “fibbing” user receives a “warning” alerting them to their indiscretion each time they fib. After a certain number of fibbing incidents, that user will receive a fibbing demerit. The user's account is suspended for a certain given time. A user may wait until that suspension passes or may pay for the premium membership to have suspension removed.

In FIG. 9, flow then passes to decision box 414 for inquiring whether a user would like to send a post-date gift to the other user. If so, the user is linked to a gift website, per step 416. Flow is then passed to decision box 418 where the user is asked whether they would like to schedule another date. If so, control passes back to FIG. 5; if not, control passes back to FIG. 4.

Other commercial integrations may be incorporated into the described matching app system. For example, activity discounts might be negotiated with sponsors of activities exclusively for subscribers to the matching app system, possibly with a percentage of collections being paid back to the sponsor of the matching app system. Also, users who have scheduled a date might be linked to websites providing products and videos that related to a scheduled date activity that users may want to purchase or watch, e.g., instructional tennis videos or dancing lessons. Discounts might be negotiated for users with instructors for in-person lessons.

In one embodiment, users are provided the option of being “exclusive” to one other user. In this case, the paired users are no longer available to other matches, and can only use the app to schedule activities with their exclusive partner. This allows committed pairs of users to use all the functionality of the matching app system, e.g., scheduling of dates/meetings, without being bothered by other users.

In one embodiment, exercise of good behavior may be rewarded with an acknowledgement on that user's profile attesting to the user's honesty, and for not ghosting, fibbing or flaking on any dates or interactions over a certain amount of time. Further rewards may include free or discounted premium features for having good behavior.

In another embodiment, a user can suggest a match profile with a friend who is not already on the app as someone that friend would find interesting.

In yet another embodiment, the matching app system may allow users to share date information with friends or family, who are not subscribers, through text messages and/or email messages, as a safety measure.

In still another embodiment, users who are single parents are able to integrate and schedule nanny care for their children through another app system which allows single parents to schedule a babysitter before going on a date.

In a further embodiment, users are provided the option of uploading a 15-second video that the user records on their phone as a greeting in which the user can say something like-Hi my name is Ryan and I love to hike, bike and play tennis. I grew up in LA and I am a photographer. Hit me up and maybe we can play some tennis.”

In a yet further embodiment, local merchants and operators of venues for activities pay a referral fee to the sponsor of the matching app system for any reservations or tickets scheduled by users of the matching app system. Similarly, online retailers who are the targets of links provided by the matching app system are able to sell products that they know the app's users are interested in based on their upcoming activities, and will pay the sponsor of the matching app system a percentage of such purchases.

Computing systems referred to herein can comprise an integrated circuit, a microprocessor, a personal computer, a server, a distributed computing system, a communication device, a network device, or the like, and various combinations of the same. A computing system may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing analog or digital information, such as in a database.

The various examples of logic noted herein can comprise hardware, firmware, or software stored on a computer-readable medium, or combinations thereof. This logic may be implemented in an electronic device to produce a special purpose computing system.

Computer-implemented steps of the methods noted herein can comprise a set of instructions stored on a computer-readable medium that when executed cause the computing system to perform the steps. A computer-readable medium, as used herein, expressly excludes paper.

A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data. Claims directed to methods herein are expressly limited to computer implemented embodiments thereof and expressly do not cover embodiments that can be performed purely mentally.

Computing systems referred to herein can comprise a personal computer, a server, a distributed computing system, a communication device, a network device, or the like, and various combinations of the same. Processors referred to herein can comprise microprocessors, for example. Chipsets referred to herein can comprise one or more integrated circuits, and memories and storage referred to herein can comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing analog or digital information, such as in a database. As such, it will be appreciated that the various examples of logic noted above can comprise hardware, firmware, or software stored on a computer-readable medium, or combinations thereof. For example, logic can include computing instructions and circuits configured to execute those computing instructions. A computer-readable medium, as used herein, refers only to non-transitory media, does not encompass transitory forms of signal transmission, and expressly excludes paper. Computer-implemented steps of the methods noted herein can comprise a set of instructions stored on a computer-readable medium that when executed cause the computing system to perform the steps.

Several embodiments are specifically illustrated and/or described herein. However, it will be appreciated that modifications and variations are covered by the above teachings and within the scope of the appended claims without departing from the spirit and intended scope thereof. For example, while certain embodiments of the invention have been described as being coordinated by a remote server, such a matching app system could instead be operated via a peer-to-peer network if desired. As one example. User2 might share his or her calendar directly with User1 to more quickly find mutually convenient dates and times to meet. While managing server 12 has been described as performing a multitude of functions for subscribers to the matching app, it will be appreciated that some or all of such functions could be performed on a user's communication device, if desired.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. The use of the term “means” within a claim of this application is intended to invoke 112(f) only as to the limitation to which the term attaches and not to the whole claim, while the absence of the term “means” from any claim should be understood as excluding that claim from being interpreted under 112(f). As used in the claims of this application. “configured to” and “configured for” are not intended to invoke Section 112(f) of the Patent Laws.

We claim:

1. A computing system configured for scheduling an activity including a first user and a second user at a location proximate to the first user and the second user, the computing system comprising:
a first communication device including a display and logic configured to determine a first location of the first communication device;
a second communication device including display and logic configured to determine a second location of the second communication device;
favorite activity logic configured for receiving information from a first user via a user interface, the information from the first user indicating activities in which the first user likes to engage;
location logic configured for receiving an approximate location of the first user based of the first communication device;
favorite activity logic configured for receiving information from a second user via a user interface, the information indicating activities in which the second user likes to engage;
location logic configured for receiving an approximate location of the second user based on the second location of the second communication device;
activity logic configured for selecting activities in which both the first user and the second user like to engage,
the activity logic being further configured to filter the activities based on the approximate location of the first user and the approximate location of the second user, to identify a suggested activity at a location generally near the first user and the second user that both the first user and the second user like to engage;
a display configured for displaying to the first user the identity of the second user, the suggested activity, and the location generally near the first user and second user; and
logic configured for the first user to send an electronic message to the second user including an invitation for the second user to meet with the first user to engage in the suggested activity at the established location.

2. The computing system of claim 1 further including:
logic configured for receiving information from the first user regarding calendar entries for the first user;
logic configured for establishing a date and time when the first user is available to meet with the second user to engage in the suggested activity and displaying to the first user the time and date when the first user is available to meet with the second user to engage in the suggested activity; and
logic configured for allowing the first user to add the aforementioned time and date to the electronic message sent by the first user to the second user.

3. The computing system of claim 1, further including logic configured to receive indications from the first user and the second that they wish to have an exclusive relationship and to alter operation of the activity logic from a first mode in which the first user is matched to activities with multiple other users to a second mode in which the first user is only matched to activities with the second user.

4. The computing system of claim 1 further including logic configured for providing a list of activities to the first user for allowing the first user to select a plurality of such activities, wherein the list of activities is filtered by location of the first user as determined using GPS and the location of the second user.

5. The computing system of claim 1 wherein the logic configured to determine a first location of the first communication device is configured to determine the first location using GPS.

6. The computing system of claim 1 wherein the image displayed to the first user, displaying the identity of the second user, the suggested activity, and the established location, includes a map on which the established location is designated.

7. The computing system of claim 1 wherein the first user's display includes an electronic screen, and wherein the first user may obtain additional information regarding the established location by selecting the established location on the electronic screen.

8. The computing system of claim 1 further including chat logic configured for allowing the first user and the second user to exchange chat messages with each other.

9. The computing system of claim 8 further including logic configured for allowing the first user to send a request to the second users to reply to an unanswered chat message.

10. The computing system of claim 8 further including logic configured to determine if the second user fails to respond to a chat message from the first user for a pre-determined amount of time, for providing the second user with an alert indicating this failure and for providing the second user with a ghosting demerit for this failure.

11. The computing system of claim 1 further including logic configured for registering an objection from one of the first and second users when the other user fails to attend a scheduled meeting without reasonable prior notice.

12. The computing system of claim 1 further including logic configured for registering an objection from the first user that the second user has misrepresented a location of the second user.

13. The computing system of claim 1 further including logic configured for receiving advertisements from proprietors of locations at which activities are conducted, and wherein the logic configured for establishing a location generally near the first user and the second user at which the suggested activity can be shared searches such advertisements for an advertised location.

14. The computing system of claim 1 wherein the display is included in a communication device associated with the first user, and wherein such display includes an icon to schedule ride-share transportation for transporting one of the first and second users to the established location.

15. The computing system of claim 1 wherein the display is included in a communication device associated with the first user, and wherein such display includes an icon for purchasing a gift for the second user.

16. The computing system of claim 1 wherein the display is included in a communication device associated with the first user, and wherein such display includes an icon for purchasing a product for use during the suggested activity at the established location.

17. A computing system for allowing first and second users of a social media matching application to schedule personal meetings between the first and second users to the exclusion of a plurality of other users of such social media matching application, the computing system comprising:
logic configured to receive information from the first user indicating that the first user does not wish to meet with other users apart from the second user;
logic configured to receive information from the second user indicating that the second user does not wish to meet with other users apart from the first user;
logic configured to receive information from the first user and the second user indicating activities in which the first and second users like to engage;
logic configured to receive information indicating the approximate locations of the first user and the second user;
logic configured to detect the activities in which the first user and the second user like to engage, and to suggest a proposed activity in response thereto;
logic configured to establish a location generally near the first user and the second user at which the suggested activity can be shared;
logic configured to display to the first user the suggested activity and the established location; and
logic configured to allow the first user to send an electronic message to the second user including an invitation for the second user to meet with the first user to engage in the suggested activity at the established location.

18. A computing system for matching a first user with a second user, the computing system comprising:
logic configured to receive information from a first user for identifying attributes of the first user;
logic configured to receive information from a plurality of other users for identifying attributes of each of the other users;
logic configured to compare identifying attributes of the first user with identifying attributes of the plurality of other users, and to propose match candidates to the first user based upon such comparison;
logic configured to permit the first user to exchange electronic chat messages with at least one the proposed match candidates;
logic configured to permit the first user to terminate the exchange of electronic chat messages with a proposed match candidate by sending an electronic termination message to such proposed match candidate advising that there is no interest in chatting further, such termination message being configured to prevent the first user from automatically receiving a ghosting demerit;
logic configured to stop the transmission of further electronic chat messages from a terminated match candidate to the first user; and
logic configured to stop the transmission of further electronic chat messages from the first user to the terminated match candidate after allowing the termination message to be received by the terminated match candidate.

19. The computing system recited by claim 18 wherein the computing system further includes monitoring logic configured to monitor chat messages exchanged between the first user and proposed match candidates, and wherein such monitoring logic is further configured to issue the ghosting demerit to the first user or proposed match candidates for failing to respond to a chat message within a pre-determined period of time.
